(19) United States
(12) Patent Application Publication
(10) Pub. No.: US 2025/0236330 A1
(43) Pub. Date: Jul. 24, 2025

(54) Ski Mount Clamp

(71) Applicant: Merin Swasey, North Logan, UT (US)

(72) Inventor: Merin Swasey, North Logan, UT (US)

(73) Assignee: Merin Swasey, North Logan, UT (US)

(21) Appl. No.: 19/027,581

(22) Filed: Jan. 17, 2025

Related U.S. Application Data
(60) Provisional application No. 63/620,821, filed on Jan. 13, 2024.

(51) Int. Cl. B62B 13/18

(52) U.S. Cl. CPC B62B 13/18

(57) ABSTRACT

Clamping mechanism for a ski, board, or other object that includes two linearly coupled jaws that increase or decrease the distance between each other. A lever controlling mechanism with an eccentric pivot that controls the movement of the jaws to increase or decrease the distance between each other, and that overcams in the locking position, thus tending to keep the mechanism closed or in the locked position. A clamp plate that is clamped between the two aforementioned jaws, such that it self-centers and limits the degrees of freedom in all directions relative to the mounted clamp.

### BACKGROUND OF THE INVENTION

Skis or boards used in the sporting industry or other objects that are typically mounted to the equipment using a fixed method. For example, a ski bike used in winter, uses fasteners that are inserted through the frame and into the ski, which makes the ski fixed to the frame and is not easily removable. This presents a problem to the user in which the ski bike frame with the skis installed makes the overall length of the ski bike fairly long. This makes transportation of the ski bike difficult. It also does not allow the user to easily switch skis out due to changing snow conditions throughout the day. As ski bikes become increasingly popular, users want to be able to transport their equipment more easily by removing the skis, and be able to quickly switch out skis based on the current conditions or change them for riding style.

### SUMMARY OF THE INVENTION

Clamps for mounting skis, boards, or other items to hardware embodying the invention allows the user quickly mount or remove these items by clamping or unclamping a clamp plate that is mounted to the ski, board, or other object. The clamp mechanism in various embodiments, may be operated using a lever for clamping or unclamping. Note as used herein and in the accompanying claims, the terms “locked” and “unlocked” refer to the fully clamped and fully unclamped positons respectively.

A mounted clamp mechanism embodying the invention for skis, boards or other items includes a fixed clamp jaw and a movable clamp jaw that are linearly coupled as to move closer together or farther apart when the clamp mechanism lever is actuated. The fixed portion of the mounted clamp is attached to the hardware with fasteners or some other type of fixed method.

The controlled movement of the sliding jaw embodying the invention is accomplished with a lever that is mounted at a pivot point with a bushing that is located eccentrically to the lever pivot. A rod is connected to the bushing and the movable jaw. When the lever is actuated, this allows the movable jaw to move farther away or closer, relative to the fixed jaw.

In one embodiment of the invention, the stationary jaw is fixed to the hardware (ski bike, etc.) typically with fasteners or other permanent methods, and the other jaw is linearly coupled and movable relative to the stationary jaw.

In various embodiments, the invention includes a clamp plate that is fastened or otherwise locked to the ski, board or other item, which when the mounted clamp is actuated using the lever, the movable jaw quickly clamps to the locked position with a large force, or unclamps (unlocked position) which quickly releases the clamp plate. The geometry of the clamp plate provides that when the clamp is moving to the locked position, the plate is automatically aligned and all degrees of freedom are removed for the item (ski, etc.).

The mounted clamp embodying the invention also includes a spring loaded ball which when the lever is in the clamped position, the spring loaded ball recesses into a hole on the lever which helps prevent the lever from moving to the unlocked position in vibrational environments.

For the purposes of this document, the term “mounted clamp” refers to the mechanism that includes the fixed jaw and movable jaw that is attached or fixed to the hardware (ski bike, etc). The term “clamp plate” is the plate that is attached or fixed to the ski, board, or item.

### BRIEF DESCRIPTION OF DRAWINGS

Reference to the accompanying drawings will be made, which are not necessarily to scale, and wherein:

FIG. 1A is a simplified isometric view of the mounted clamp (110) and clamp plate (7) in one embodiment of the invention attached to hardware (ski bike 90, and ski 80) before each are locked together;

FIG. 1B is a simplified isometric view of the mounted clamp and clamp plate mechanism in one embodiment of the invention as they are locked together;

FIG. 2 is a simplified exploded view showing the major components comprising the mounted clamp and clamp plate mechanism (100) embodying the invention;

FIG. 3A is a simplified cross sectional view of the mounted clamp assembly (110) embodying this invention in the unlocked state;

FIG. 3B is a simplified cross sectional view of the mounted clamp mechanism (110) embodying this invention in the locked state;

FIG. 4A is a simplified isometric view of the “fixed side” of the mounted clamp mechanism and clamp plate (100) embodying this invention in the unlocked state, noting that the term “fixed side” is only a descriptive term used to explain the embodied invention, noting that this is the side or surface that is fixed to the hardware (90 in FIG. 1), and this term will be used throughout the document;

FIG. 4B is a simplified isometric view of the mounted clamp and clamp plate mechanism (100) embodying this invention in the locked state;

FIG. 5 is a simplified isometric view of the “clamping side” of the mounted clamp mechanism embodying this invention in the unlocked state, showing some of the major components, noting that the term “clamping side” is only a descriptive term used to explain the embodied invention, noting that this is the side where the clamp plate (7) is inserted, again noting that this term will be used throughout the document;

FIG. 6A is a simplified isometric view of the clamping side of mounted clamp mechanism and clamp plate (100) embodying this invention in the unlocked position, with the clamp plate (7) detached from the mounted clamp mechanism (110);

FIG. 6B is a simplified isometric view of the clamping side of the mounted clamp and clamp plate mechanism (100) embodying this invention in the locked position, with the clamp plate (7) locked to the mounted clamp (110); and

FIG. 7 is a highly simplified cross section of the mounted clamp 110 assembly and clamp plate (7) in one embodiment of this invention showing the mechanism attached to hardware 90 and 80 in the locked state.

### DETAILED DESCRIPTION OF THE INVENTION

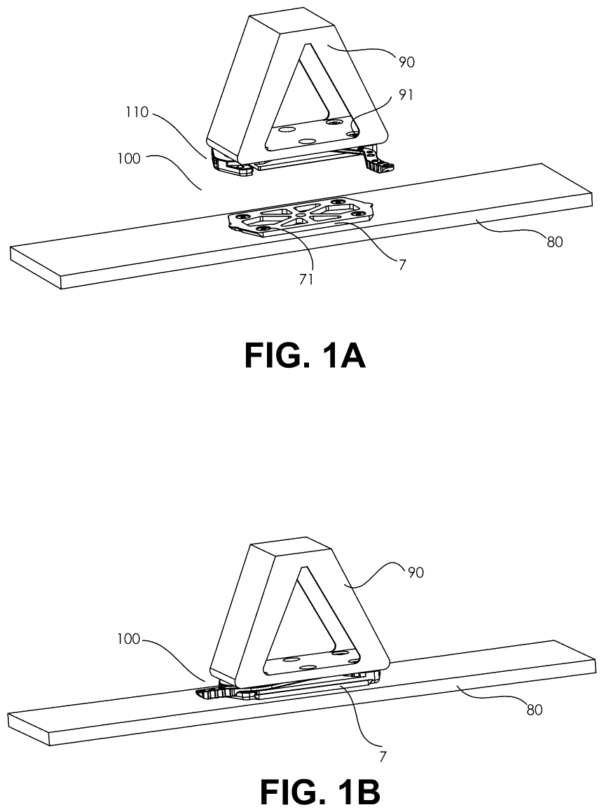

FIG. 1A and FIG. 1B show the mounted clamp and clamp plate apparatus 100 embodying the invention as it would be attached to hardware, in one embodiment as an example the mount clamp 110 is attached to a ski bike 90 using fasteners 91 and the clamp plate 7 is attached to a ski 80 using fasteners 71. FIG. 1A shows in one embodiment of the ski bike 90 along with the mount clamp 110 detached from clamp plate 7 that is attached to ski 80, where the mount clamp 110 is in the unlocked state.

FIG. 1B shows in one embodiment of the ski bike 90 coupled to ski 80 with the clamping apparatus 100 in the locked state. In this locked state, the clamp plate 7 that is attached to the ski 80 is rigidly locked into the mount clamp 110, thus comprising the mechanism 100 embodied in the invention.

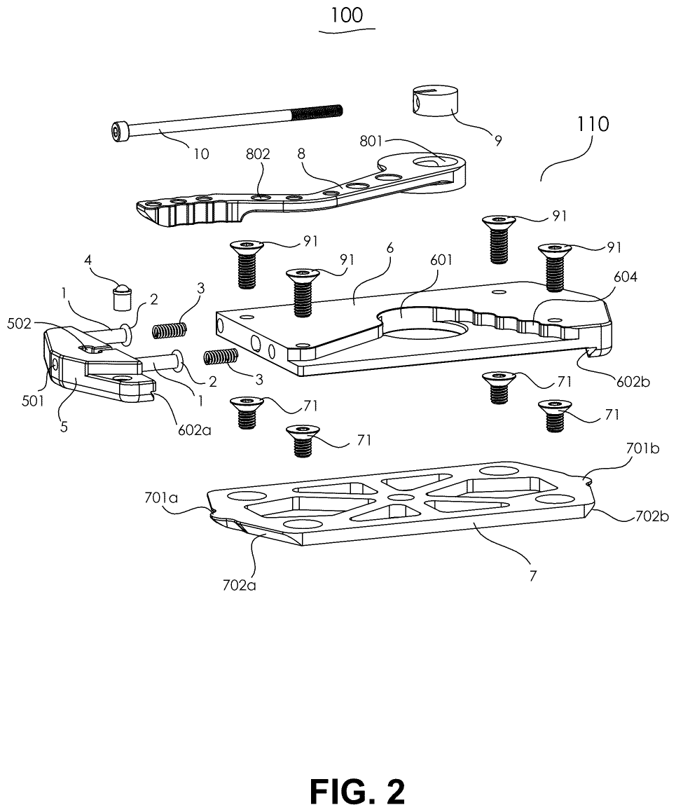

FIG. 2 shows an exploded view of the full clamping mechanism 100 embodying the invention. Components 1, 2, 3, 4, 5, 6, 8, 9, and 10 form the mounted clamp assembly 110. Fasteners 91 and 71 in one embodiment, are used to fasten the mounted clamp to the ski bike 90 and the lock plate 7 to the ski 80 respectively.

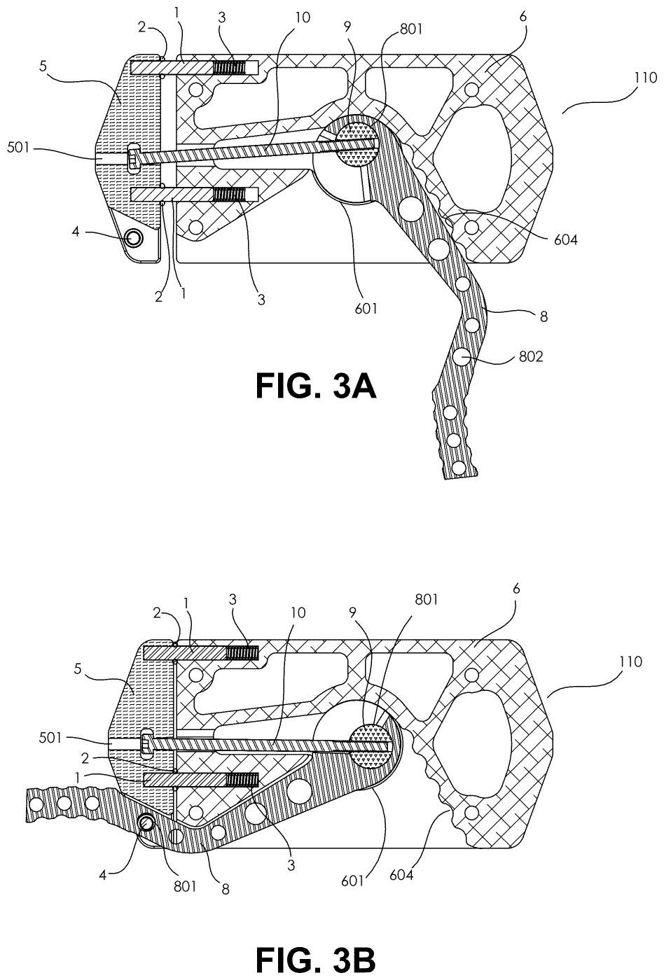

FIG. 3A and 3B shows cross sections of the mounted clamp assembly 110 embodying the invention. FIG. 3A shows the mounted clamp assembly 110 in the unlocked positon and the method in which the coupling between the fixed jaw 6 and the movable jaw 5 is shown. Likewise, FIG. 3B shows the mounted clamp assembly 110 in the locked positon. FIGS. 1A, 1B, 3A, 3B, 4A, 4B, 5, 6A, and 6B show the intercoupling and operation of the embodied invention. In FIG. 3A and 3B, the linearly movable jaw 5 is coupled to the fixed jaw 6 by the use of pins 1 and the pins slide in and out of the fixed jaw 6. The springs 3 behind the pins 1 are used to assist in sliding the movable jaw 5 to the unlocked position. When in the locked position, o-rings 2 are used to seal the pin 1 bores that are in the movable jaw 5 and the fixed jaw 6 so that contaminates cannot enter and damage the pins 1 and the bore of the fixed jaw 6. To actuate the movable jaw, the end of lever 8 is pushed and the lever rotates about the pivot point 601. Pivot block 9 is coupled to the lever 8 at the eccentric pivot 801. The pivot block 9 is also connected to the coupling rod 10 and movable jaw 5, thus when lever 8 is moved, it causes the movable jaw 5 to actuate relative to the fixed jaw. This movement is caused by the eccentricity of the axis of the lever pivot 601 and the eccentric pivot 801. In addition, when lever 8 is in the locked position, the axis of the lever pivot 601 and axis of the eccentric pivot 801 are positioned such that the tension load of the coupling rod 10 forces lever 8 to be closed, or in common terms is “overcammed” Note, that in various embodiments, there is a sliding surface between the pivot block 9 and the eccentric pivot 801. To reduce the friction of this interaction, pivot block 9 may be made from various materials or have various coatings to reduce the friction between these two surfaces. Also in various embodiments, the pivot block 9 may also be a ball bearing or some other rolling element.

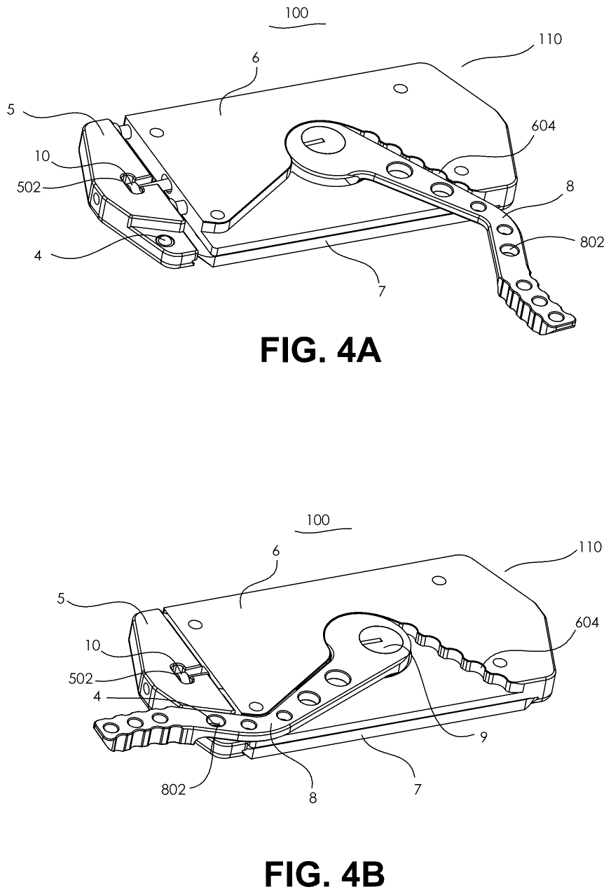

FIGS. 4A and 4B, it shows and isometric view of the mounted clamp and clamp plate mechanism 100 in the unlocked and locked state, respectively. When assembled, coupling rod 10 is inserted into the coupling rod slot 502 which the slot acts to restrict the movement of the end of the coupling rod 10. The other end of coupling rod 10 is inserted into the pivot block 9 and is fixed relative to the pivot block 9. Due to the restriction of each end of the rod, when lever 8 is rotated, the movable jaw 5 is forced to move open or closed, thus removing the ability for the movable jaw 5 to be constrained closed due to fouling of the pins 1 by dirt, ice, or other contaminant. In various embodiments of the invention, the pivot block 9 is threaded and the threaded end of the coupling rod 10 is inserted into it to fix the two components together. To adjust the gap between the fixed jaw 6 and the movable jaw 5 the connecting rod can be rotated using adjustment hole 501 shown in FIGS. 3A and 3B. This allows fine tuning of the mounted clamp 110 to adjust the pressure when it is clamped to the clamp plate 7.

Referencing FIGS. 3B, and 4B, when lever 8 is in the locked position, the spring loaded detent 4 protrudes up into the detent hole 802 on lever 8. In various embodiments of the inventions, this helps prevent the accidental release of the lever 8 from the locked position under vibrational loads. For example, in one embodiment of the invention, the spring loaded detent 4 helps prevent the lever 8 from moving to the unlocked position when a ski bike rider is riding on rough hard packed snow.

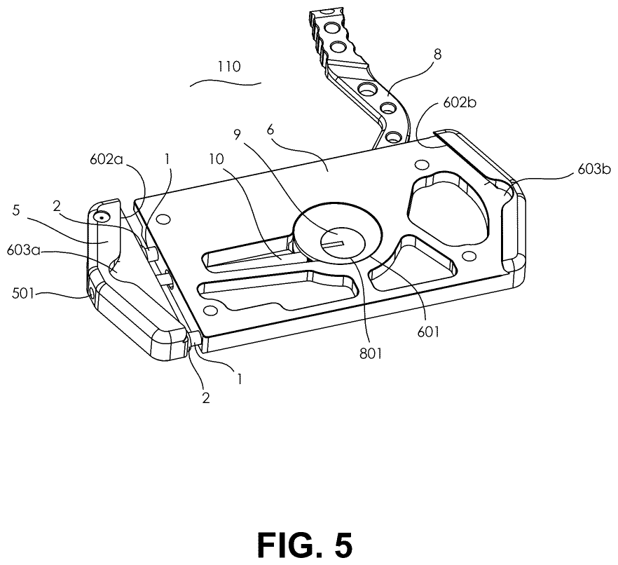

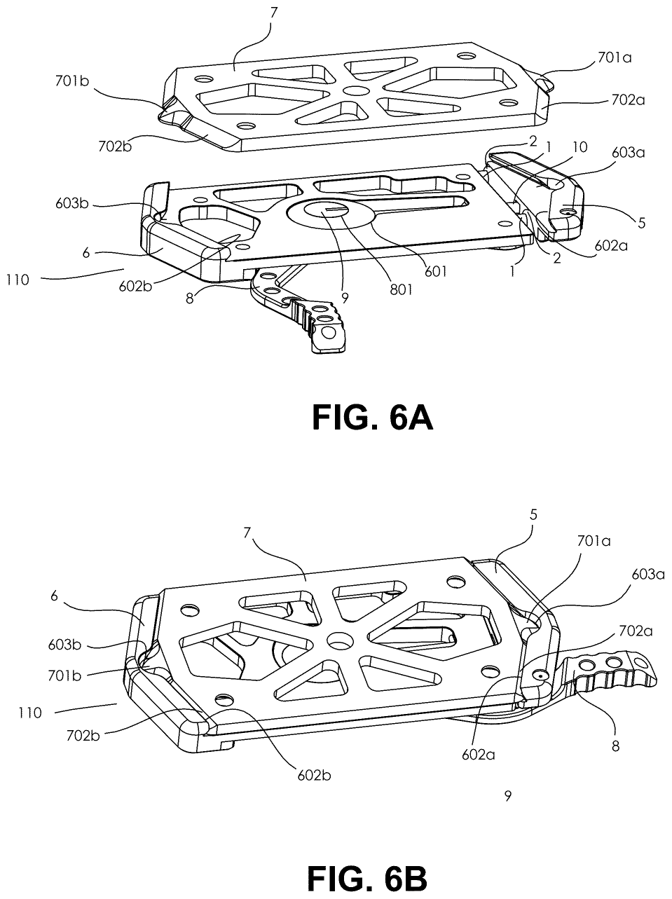

FIG. 5 shows an isometric view of the mounted clamp assembly 110 in the unlocked position. Clamp plate 7 was omitted from this view as to clearly show the features of the clamping side of the mounted clamp 110. In various embodiments of the invention, the shape of the clamping profiles on movable jaw 5 and fixed jaw 6 angle inward toward the center, which matches the profile of the clamp plate 7. In addition, the surfaces 602a and 602b are angled along with the surfaces 702a and 702b such that when the clamp plate 7 is locked into the mounted clamp assembly 110, the clamp plate 7 is restricted from moving in all degrees of freedom relative to the mounted clamp 110. Another feature of the clamp plate are the alignment ridges 701a and 701b shown in FIGS. 6A and 6B. In one embodiment of the invention, when clamp plate 7 is inserted into the mounted clamp 110 the alignment ridges 701a and 701b align with the alignment notches 603a and 603b, which forces the clamp plate 7 to self-center. In one embodiment of the invention, for example in FIGS. 1A and 1B, when clamp plate 7 is locked into the mounted clamp 110 it forces the ski 80 to be correctly aligned with the ski bike 90. It should be understood that in numerous embodiments of this invention, movable jaw 5 and fixed jaw 6 could have various shapes and contours, along with matching contours on clamp plate 7 that would restrict the movement of the clamp plate 7.

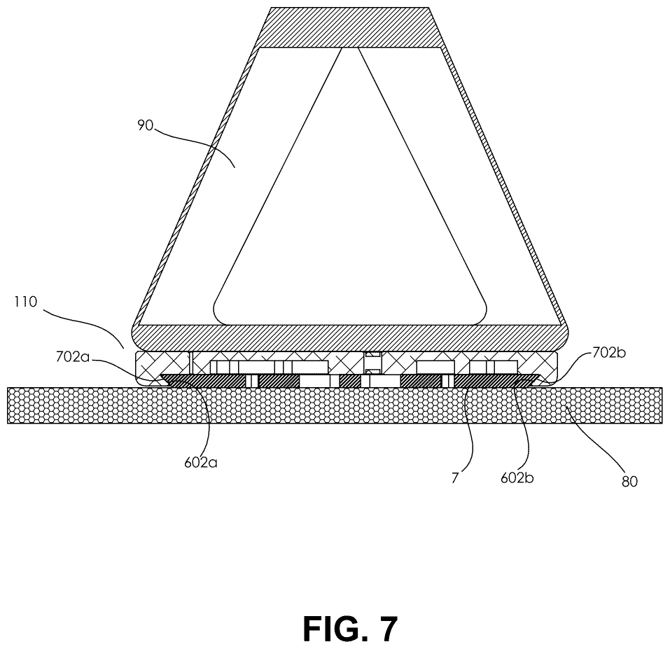

FIG. 7 shows a cross section view of one embodiment of the invention in the locked position. The mounted clamp 110 is fastened or fixed to the ski bike 90 and clamp plate 7 is fixed to ski 80, thus locking them together. In the embodiment of the invention, surfaces 702a, 602a, 702b, and 602b are matching angles as to lock the mounted clamp 110 and clamp plate 7 together and prevent relative movement between the two. In one embodiment as in FIG. 7, the angle is 45 degrees. It should be understood that the surfaces 702a, 602a, 702b, and 602b can be any angle in which it restricts relative movement between the components. In various embodiments of the invention, when the mounted clamp 110 is locked in this position, a high clamping load is induced between plate clamping face 702a and movable clamping face 602a, as well as plate clamping face 702a and fixed clamping face 602b.

1. A ski mount clamp comprising: Two clamping jaws linearly coupled to each other so when actuated, the space between the jaws increases or decreases; a jaw controlling apparatus having: (a) a lever with an eccentrically located pivot, in which is coupled around the two clamping jaws for controlling the jaws to increase or decrease the distance between aforementioned jaws and (b) the axis of the eccentrically located pivot is positioned such that when in the locked state, tends to force the lever to the locked position; a clamping plate that when clamped in the clamping mechanism, is fixed in all degrees of freedom relative to the clamping mechanism.

2. A clamp as claimed in claim 1, wherein the coupling rod is threaded as to fine tune the distance between the two linearly coupled jaws.

3. A clamp as claimed in claim 1, wherein the coupling rod is threaded as to fine adjust the clamping load on the clamping plate.

4. A clamp as claimed in claim 1, wherein a spring loaded detent is used to inhibit the lever from opening from the locked position.

5. A clamp as claimed in claim 1, wherein the coupling rod is fixed to the two coupled jaws and fixed to the eccentric portion of the lever as to force the jaws to increase or decrease the distance between them.

6. A clamp as claimed in claim 1, wherein the pivot block contained in the eccentric pivot is a rolling element, such as a bearing.

7. A clamp as claimed in claim 1, wherein the one of the jaws is fixed and the other one is movable.

8. A clamp as claimed in claim 1, wherein the clamping mechanism and the clamp plate have a geometric feature that forces the plate to self-center when the lever moves to the locked position.

9. A clamping mechanism comprising: two clamping jaws linearly coupled to each other so when actuated, the space between the jaws increases or decreases; a jaw controlling apparatus having: (a) a lever with an eccentrically located pivot, in which is coupled around the two clamping jaws for controlling the jaws to increase or decrease the distance between aforementioned jaws and (b) the axis of the eccentrically located pivot is positioned such that when in the locked state, tends to force the lever to the locked position.

10. A clamp as claimed in claim 9, wherein an object is to be clamped between the two clamping jaws.

11. A clamp as claimed in claim 10, wherein an object is to be clamped between the two clamping jaws, thus removing all degrees of freedom.
